(19) United States
(12) Patent Application Publication
(10) Pub. No.: US 2017/0125937 A1
(43) Pub. Date: May 4, 2017

(54) WATERPROOF STRUCTURE OF CARD TRAY HOLE OF MOBILE PHONE WITH METALLIC SHELL

(71) Applicants: Le Holdings (Beijing) Co., Ltd., Beijing (CN); Lemobile Information Technology (Beijing) Co., Ltd., Beijing (CN)

(72) Inventors: Yongchun LIANG, Beijing (CN); Dan YU, Beijing (CN); Dun TIAN, Beijing (CN); Shengmao CAI, Beijing (CN); Fei ZHANG, Beijing (CN); Hui WANG, Beijing (CN)

(21) Appl. No.: 15/240,632

(22) Filed: Aug. 18, 2016

Related U.S. Application Data
(63) Continuation of application No. PCT/CN2016/086086, filed on Jun. 16, 2016.

(30) Foreign Application Priority Data
Oct. 30, 2015 (CN) 2015107340615

(51) Int. Cl. H01R 13/52; H01R 12/72; H01R 13/635

(52) U.S. Cl. CPC H01R 13/5202; H01R 13/635; H01R 12/721

(57) ABSTRACT

The present invention discloses a waterproof structure of a card tray hole of a metallic-shell mobile phone. The waterproof structure includes: an SIM card seat; a card tray arranged in the SIM card seat; a card tray push rod which is arranged at one side of the SIM card seat and is used for pushing the card tray so as to eject the card tray out of the shell; and a waterproof sealing needle, which is arranged in a card tray push rod hole formed on the shell of the mobile phone and corresponding to the card tray push rod. The waterproof structure of the card tray hole of the metallic-shell mobile phone can prevent water from entering a shell inside from a shell outside, thereby achieving the waterproof effect.

### CROSS-REFERENCE TO RELATED APPLICATIONS

This application is a continuation of International Application No. PCT/CN2016/086086, filed on Jun. 16, 2016, which is based upon and claims priority to Chinese Patent Application No. 201510734061.5, filed on 30 Oct. 2015, the entire contents of which are incorporated herein by reference.

### TECHNICAL FIELD

The present invention relates to the fields of mobile phones, and particularly relates to a waterproof structure of a card tray hole of a metallic-shell mobile phone.

### BACKGROUND

As shown in FIG. 1, as to a conventional metallic-shell mobile phone, an SIM (Subscriber Identity Module) card is usually placed on a card tray 12 in an SIM card seat 11 positioned on a PCB (Printed Circuit Board) 18 of the mobile phone. When the SIM card is mounted and removed, a needle-shaped push rod pushes a card tray push rod 15 on the SIM card seat into the shell through a card tray push rod hole 14 formed in a shell 13, the card tray 12 is pushed out and the SIM card can be taken, then the SIM card tray is pressed in, and the push rod is reset.

As shown in FIG. 2, due to existence of the card tray push rod hole 14, water is likely to leak into the shell inside 17 of the mobile phone from a shell outside 16 by the card tray push rod hole 14, so as to cause a short circuit or corrosion of components whereby the mobile phone is damaged.

Information disclosed in the background art only is intended to facilitate understanding of the overall background of the present invention, but shall not be deemed as admitting or implying in any form that the information constitutes the prior art well known by those skilled in the art.

### SUMMARY

The present invention aims to provide a simple and reasonable waterproof structure of a card tray hole of a mobile phone with metallic shell. According to the waterproof structure of the present invention, a waterproof sealing needle is arranged in a card tray push rod hole outside a card tray push rod so as to seal the card tray push rod hole to achieve waterproof effect. A needle-shaped push rod pushes the waterproof sealing needle to push the card tray push rod, so as to eject a card tray out of a shell, and then SIM card can be taken out or put in. In this way, water can be prevented from entering a shell inside from a shell outside, and thus, waterproof effect is achieved, and damage to the mobile phone, which is caused by a short circuit or corrosion of the components, is avoided.

To this end, the present invention provides a waterproof structure of the card tray hole of the metallic shell mobile phone, which includes: an SIM card seat which is positioned at on a upper side of a PCB (Printed Circuit Board) of the mobile phone; a card tray which is arranged in the SIM card seat and is used for carrying the SIM card; a card tray push rod which is arranged at one side of the SIM card seat and is used for pushing the card tray so as to eject the card tray out of the shell; and a waterproof sealing needle arranged in the card tray push rod hole which is formed in the shell of the mobile phone and corresponds to the card tray push rod so as to seal the card tray push rod hole to achieve waterproof effect.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a local section view of a waterproof structure of a card tray hole of a conventional metallic-shell mobile phone.

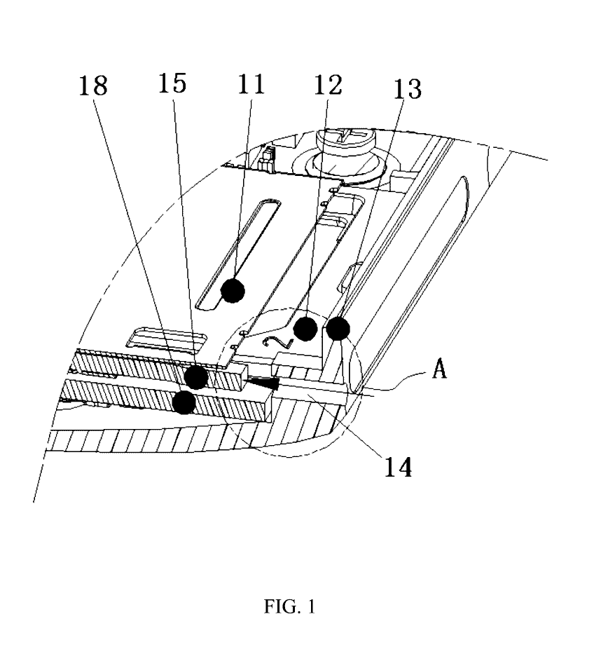

FIG. 2 is an amplified schematic view of the A part of FIG. 1.

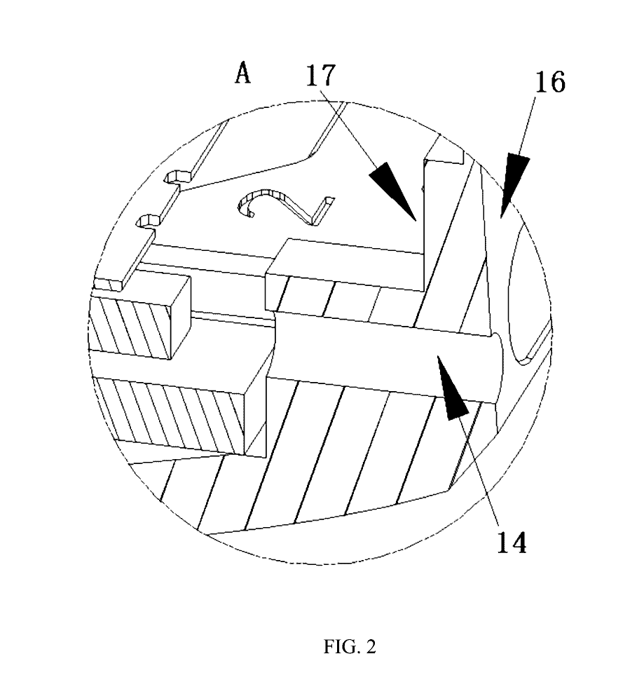

FIG. 3 is a partial section view of a waterproof structure of a card tray hole of a mobile phone with metallic shell of the present invention.

FIG. 4 is an amplified schematic view of the B part of FIG. 3.

FIG. 5 is an exploded schematic view of a waterproof sealing needle of the waterproof structure of the card tray hole of the mobile phone with metallic shell of the present invention.

### DETAILED DESCRIPTION

Specific embodiments of the present invention will be described in details below with reference to the accompanying drawings, but it should be understood that the protection scope of the present invention is not limited to the specific embodiments.

Unless otherwise defined, in the whole description and claims, terms such as “include” or variations thereof, such as “comprise” or “is composed of”, and the like shall be understood that the elements or components are covered, not exclusive of other elements or other components.

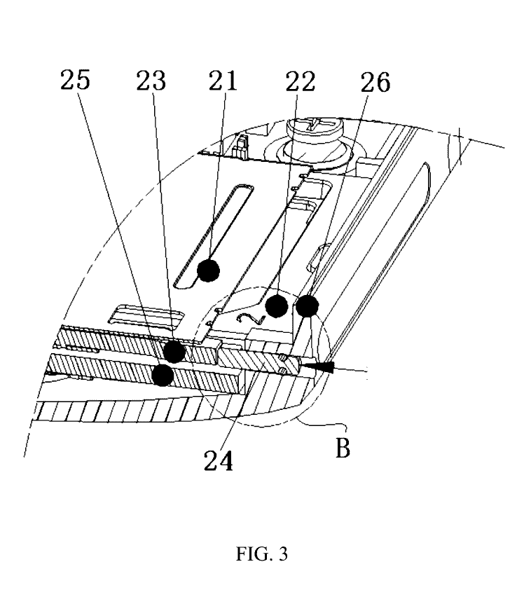

As shown in FIG. 3 to FIG. 5 (arrows in the Figs represent thrust force), according to the embodiments of the present invention, a waterproof structure of a card tray hole of a mobile phone with metallic shell includes: an SIM (Subscriber Identity Module) card seat 21, a card tray 22, a card tray push rod 23 and a waterproof sealing needle 24. The SIM card seat 21 is positioned on a upper side of a PCB (Printed Circuit Board) 25 of the mobile phone, and the card tray 22 is arranged in the SIM card seat 21 and is used for carrying an SIM card. The card tray push rod 23 is arranged at one side of the SIM card seat 21 and is engaged with the card tray 22. The card tray push rod 23 can eject the card tray 22 out of a shell and then the SIM card can be taken out or put in the card tray 22. A card tray push rod hole 27 corresponding to the card tray push rod 23 is formed in the shell 26 of the metallic-shell mobile phone. A waterproof sealing needle 24 is arranged in the card tray push rod hole 27 so as to seal the card tray push rod hole to achieve waterproof effect. A needle-shaped push rod pushes the waterproof sealing needle to push the card tray push rod, so as to eject the card tray out of the shell 26, and then the SIM card can be taken out or put in. In this way, water can be prevented from entering a shell inside from a shell outside, and thus, waterproof effect for components is achieved, and damage to the mobile phone, which is caused by a short circuit or corrosion of the components, is avoided.

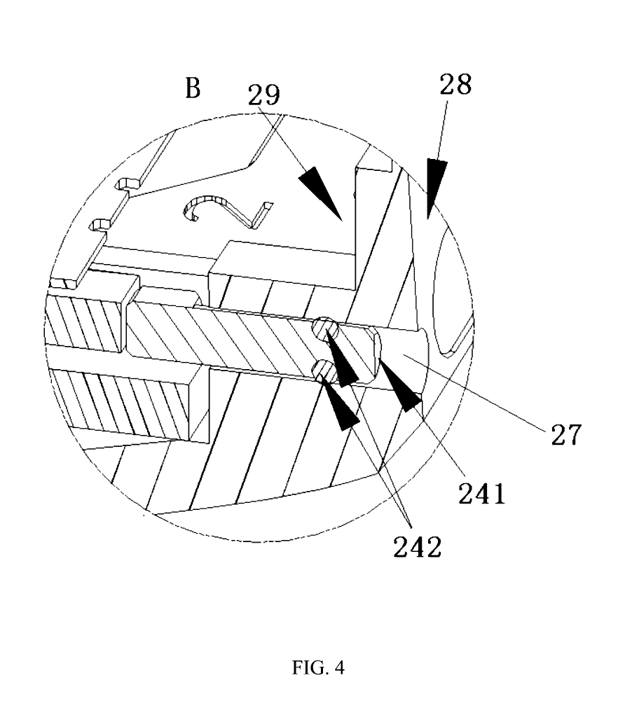

Specifically speaking, as shown in FIG. 3 and FIG. 4, the PCB (Printed Circuit Board) is an important electronic part and functions as a support of electronic components and a carrier for electrical connection of the electronic components. The PCB is made by electroprinting, hence is named as “printed circuit board”. The PCB 25 of the mobile phone is arranged in the shell 26, the SIM card seat 21 is positioned on the PCB 25 of the mobile phone, and the card tray 22 is arranged in the SIM card seat 21 and is used for carrying the SIM card.

The card tray push rod 23 engaged with the card tray 22 is arranged at one side of the SIM card seat 21, and by pushing the card tray push rod 23, the card tray 22 can be ejected out of the shell 26 and then the SIM card can be taken out of or put in the card tray 22.

The card tray push rod hole 27 corresponding to the card tray push rod 23 is formed on the shell of the metallic shell mobile phone, and the card tray push rod hole 27 is used as a passage for enabling the needle-shaped push rod to push the card tray push rod to eject the card tray out of the shell so as to achieve taking or assembling of the SIM card, but due to existence of the card tray push rod hole, water can easily enter the shell inside 29 of the mobile phone from the shell outside 28 through the card tray push rod hole 27 to cause the short circuit or corrosion of the components so as to cause damage to the mobile phone.

The waterproof sealing needle of the card tray hole of the mobile phone with metallic shell according to an embodiment of the present invention is arranged so as to seal the card tray push rod hole to obtain the waterproof effect. The waterproof sealing needle 24 is arranged in the card tray push rod hole 27 so as to seal the card tray push rod hole to stop the water from entering, and the needle-shaped push rod pushes the waterproof sealing needle to push the card tray push rod to eject the card tray out of a shell, and then the SIM card can be taken out or put in. In this way, water can be prevented from entering the shell inside from the shell outside, and thus, waterproof effect for components is achieved, and damage to the mobile phone, which is caused by the short circuit or corrosion of the components, is avoided.

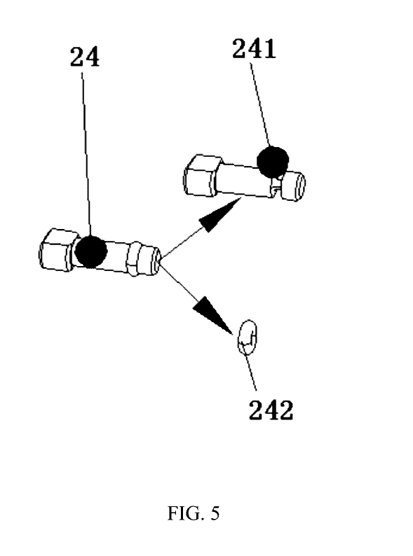

As shown in FIG. 5, the waterproof sealing needle 24 includes a sealing needle body 241 and an elastic sealing ring 242 mounted near the outer end of the sealing needle body. The sealing needle body 241 and the elastic sealing ring 242 are formed as an integral structure or an assembled structure. The sealing needle body 241 has a cylinder shape matched with the card tray push rod hole 27, and the inner end face of the sealing needle body 241 is used as a pushing face for the card tray push rod 23 and is in contact with the card tray push rod 23. The outer end face of the sealing needle body 241 is used as a contact face for the needle-shaped push rod, so that the waterproof sealing needle is pushed by the needle-shaped push rod to push the card tray push rod to eject the card tray out of the shell and then the SIM card can be taken out or put in. A stop flange is also formed adjacent the inner end of the sealing needle body 241 so as to prevent the waterproof sealing needle 24 from slipping out of the card tray push rod hole 27. A sealing ring groove is formed near the outer end of the sealing needle body 241 in the circumferential direction and is used for receiving the elastic sealing ring 242. The elastic sealing ring 242 is provided near the outer end of the sealing needle body. When the waterproof sealing needle 24 is arranged in the card tray push rod hole 27, the elastic sealing ring 242 is in interference fit with the card tray push rod hole 27, and then a continuous tension is generated between the elastic sealing ring 242 and the card tray push rod hole 27, so that water can be prevented from entering the shell inside from the shell outside; and moreover, in the sliding process of the waterproof sealing needle, the tension continuously exists, thereby achieving long-term waterproof effect of the waterproof sealing needle in the using process. However, when the push rod pushes the waterproof sealing needle, the waterproof sealing needle slides backward to push the card tray push rod, and then the card tray push rod ejects the card tray out of the shell so that the SIM card can be taken out or put in; and then the SIM card tray is pressed into the shell, the SIM card tray push rod is reset, and the waterproof sealing needle is driven to be reset so as to complete one cycle of the whole action.

From the above, according to the waterproof structure of the card tray hole of the metallic shell mobile phone, a waterproof sealing needle is arranged in a card tray push rod hole outside a card tray push rod so as to seal the card tray push rod hole to achieve waterproof effect. A needle-shaped push rod pushes the waterproof sealing needle to push the card tray push rod, so as to eject a card tray out of a shell, and then SIM card can be taken out or put in. In this way, water can be prevented from entering a shell inside from a shell outside, and thus, waterproof effect is achieved, and damage to the mobile phone, which is caused by a short circuit or corrosion of the components, is avoided.

The specific exemplary embodiments of the present invention are described as above for the purposes of explanation and exemplary illustration. These descriptions are not intended to define the present invention into the accurate form disclosed herein, and it is obvious that according to the teaching, various changes and variations can be made. Selection and description of the exemplary embodiments are intended to explain the specific principles of the present invention and its practical application, so that those skilled in the art can implement and utilize various different exemplary embodiments of the present invention and various different selections and changes thereof. The scope of the present invention is intended to be defined by the claims and its equivalent forms.

What is claimed is:

1. A waterproof structure of a card tray hole of a mobile phone with metallic shell, comprising:
an SIM card seat positioned on a upper side of a PCB of the mobile phone;
a card tray arranged in the SIM card seat and is used for carrying an SIM card;
a card tray push rod which is arranged at one side of the SIM card seat, and is used for pushing the card tray so as to eject the card tray out of the shell; and
a waterproof sealing needle arranged in a card tray push rod hole which is formed in the shell of the mobile phone and corresponds to the card tray push rod, so as to seal the card tray push rod hole to achieve the waterproof effect.

2. The waterproof structure of the card tray hole according to claim 1, wherein the waterproof sealing needle comprises a sealing needle body and an elastic sealing ring mounted on an outer end of the sealing needle body.

3. The waterproof structure of the card tray hole according to claim 2, wherein the sealing needle body and the elastic sealing ring are formed as an integral structure or an assembled structure.

4. The waterproof structure of the card tray hole according to claim 3, wherein the sealing needle body has a cylinder shape matched with the card tray push rod hole, and a sealing ring groove is formed at the outer end of the sealing needle body in the circumferential direction and wherein the sealing ring groove is used for receiving the elastic sealing ring.

5. The waterproof structure of the card tray hole according to claim 4, wherein a stop flange is also formed at the inner end of the sealing needle body.
